(19) United States
(12) Patent Application Publication
(10) Pub. No.: US 2012/0162854 A1
(43) Pub. Date: Jun. 28, 2012

(54) MULTILAYER CERAMIC CAPACITOR

(75) Inventor: Daisuke IWANAGA, Tokyo (JP)

(73) Assignee: TDK CORPORATION, Tokyo (JP)

(21) Appl. No.: 13/337,856

(22) Filed: Dec. 27, 2011

(30) Foreign Application Priority Data
Dec. 27, 2010 (JP) 2010-290670

(51) Int. Cl. H01G 4/30

(52) U.S. Cl. 361/301.4

(57) ABSTRACT

The present invention relates to a multilayer ceramic capacitor which is superior in stability of temperature characteristic of specific permittivity and has a high specific permittivity and a high reliability. Said multilayer ceramic capacitor is characterized in that the dielectric layers include BTZ based dielectric ceramic composition, in which Ti is substituted by 1 to 8 mol % of Zr with respect to Ti, as a main component, dielectric particles constituting the BTZ based dielectric ceramic composition substantially do not have shell structures, and Curie temperature of the BTZ based dielectric ceramic composition is higher than a temperature range of the multilayer ceramic capacitor used.

### BACKGROUND OF THE INVENTION

1. Field of the Invention

The present invention relates to a multilayer ceramic capacitor.

2. Description of the Related Art

The multilayer ceramic capacitor is widely used as a size-reduced and a high capacity electronic equipment showing a high reliability; and a large number of the capacitors are used in one electronic device. The multilayer ceramic capacitor is normally manufactured by stacking internal electrode layer paste and dielectric layer paste with the use of a sheet method or a printing method, and by simultaneously firing the internal electrode layers and the dielectric layers in a stacked body.

In recent years, with the size-reduction and high performance of electronic device, a demand for further reduction in size and higher performance of multilayer ceramic capacitor used for the electronic device is rapidly increasing. For realization of the reduction in size and higher performance, development of dielectric ceramic suitable for a thinner layer and for a high stacking of dielectric layers is requested.

For instance, Japanese Unexamined Patent Publication No. 2008-239407 describes dielectric ceramic having core-shell structure and Curie temperature of 80 to 90° C. However, the dielectric ceramic described in the publication has a specific permittivity of approximately 4,000 at most, and that there is a demand for further improvement of its specific permittivity. Furthermore, the dielectric ceramic of the publication has a drawback of reliability on high-temperature load lifetime and that there is a demand for further improvement of its reliability.

### BRIEF SUMMARY OF THE INVENTION

The present invention has been made by considering the above circumstances, and a purpose of the present invention is to provide a multilayer ceramic capacitor which is superior in a stability of temperature characteristic of specific permittivity and has a high specific permittivity and a high reliability.

As a result of intentional study by the present inventors for the multilayer ceramic capacitor which is superior in stability of temperature characteristic of specific permittivity and has a high specific permittivity and a high reliability, they found that, by setting Curie temperature of BTZ based dielectric ceramic composition higher than a temperature range of the multilayer ceramic capacitor used and by increasing electric intensity which generates in dielectric layer, specific permittivity becomes stably high within the temperature range in which the multilayer ceramic capacitor is used, which lead to the completion of the present invention.

Namely, in order to achieve the above purpose, multilayer ceramic capacitor according to the present invention is a multilayer ceramic capacitor in which dielectric layers and internal electrode layers are alternately stacked, wherein the dielectric layers include BTZ based dielectric ceramic composition, in which Ti is substituted by 1 to 8 mol % of Zr with respect to Ti, as a main component, dielectric particles constituting the BTZ based dielectric ceramic composition substantially do not have shell structures, and Curie temperature of the BTZ based dielectric ceramic composition is higher than a temperature range of the multilayer ceramic capacitor used.

With the multilayer ceramic capacitor according to the present invention, electric intensity is increased by making thinner dielectric layers which makes it possible to maintain nearly constant specific permittivity, preferably around 4,000 or more within the temperature range of the use. Note that, in the present invention, Curie temperature of dielectric ceramic composition is a temperature at which specific permittivity has a maximum peak.

Curie temperature Tc of the BTZ based dielectric ceramic composition is preferably 85° C.≦Tc≦110° C., more preferably, 90° C.≦Tc≦110° C. When Curie temperature is within this range, within a temperature range of the use (−55° C. to 85° C.) particularly determined for X5R, it is possible to maintain nearly constant specific permittivity, such as around 4,000 or more. Further, within −55° C. to 85° C., capacitance change rate becomes within ±15% which satisfies X5R characteristic.

Preferably, thickness of the dielectric layer is 3 μm or less, more preferably, 1 μm or less, particularly preferably 0.7 μm or less. By making the thickness of the dielectric layer thinner, electric intensity increases and specific permittivity can be maintained nearly constant at preferably 4,000 or more, more preferably 5,000 or more and the most preferably 6,000 or more.

Preferably, the BTZ based dielectric ceramic composition is dielectric oxide shown by a general formula: (Ba₁₋ₓCaₓ)ₘ(Ti_{1-y}Zr_{y})O₃ wherein 0≦x≦0.06, 0.01≦y≦0.8 and 0.950≦m≦1.050. By using BTZ based dielectric ceramic composition, it will be easy to obtain dielectric ceramic composition wherein dielectric particles substantially do not have shell structure, Curie temperature of BTZ based dielectric ceramic composition is higher than the temperature range of use of the multilayer ceramic capacitor, and specific permittivity becomes stably high within the temperature range of the use.

### BRIEF DESCRIPTION OF THE DRAWINGS

FIG. 1 is a cross-sectional view of a multilayer ceramic capacitor according to an embodiment of the present invention.

FIG. 2 is an enlarged cross-sectional view of main part of a dielectric layer shown in FIG. 1.

FIG. 3 is a graph showing temperature characteristic of the multilayer ceramic capacitor according to the present invention.

FIG. 4 is a graph showing changes of Curie temperature by changes in additive amount (y) of Zr in BTZ based dielectric ceramic composition.

FIG. 5 (A) is a SEM cross sectional picture of a dielectric layer of multilayer ceramic capacitor according to examples of the invention.

FIG. 5 (B) is a SEM cross sectional picture of a dielectric layer of multilayer ceramic capacitor according to comparative examples of the invention.

### DETAILED DESCRIPTION OF THE INVENTION

Hereinafter, the present invention will be described based on embodiments of the invention.

### Multilayer Ceramic Capacitor

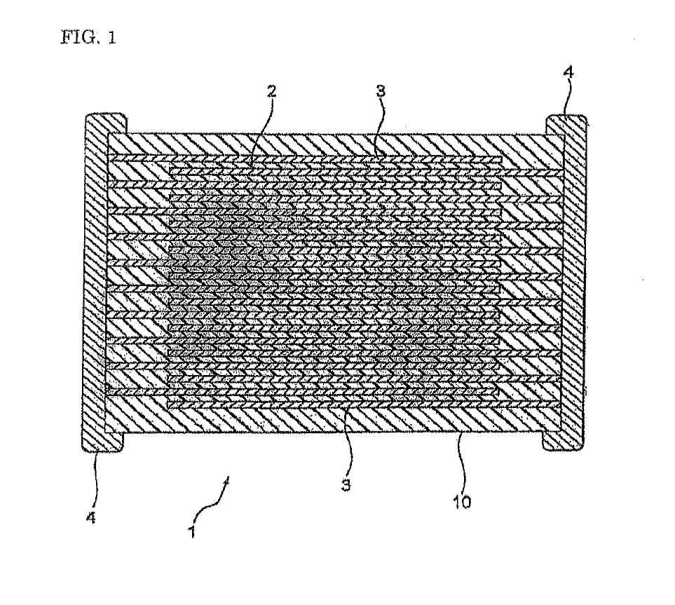

As is shown in FIG. 1, multilayer ceramic capacitor 1 according to an embodiment of the present invention has a capacitor element body 10 in which dielectric layers 2 and internal electrode layers 3 are alternately stacked. End portions on both sides of the capacitor element body 10 are formed with a pair of external electrodes 4 respectively conducting to the internal electrode layers 3 arranged alternately in the capacitor element body 10. Shape and dimension of capacitor element body 10 is not particularly limited, and may be suitably selected according to its use. Normally, it is nearly a rectangular parallelpiped and its size is approximately (0.15 to 5.6 [mm]) length×(0.2 to 5.0 [mm]) width×(0.1 to 1.9 [mm]) thickness.

The internal electrode layers 3 are stacked so that the end surfaces are alternately exposed to facing surfaces of the end portions of the capacitor element body 10. A pair of external electrodes 4 are formed on end portions on both sides of the capacitor element body 10 and are connected to exposed end surfaces of internal electrode layers 3 that are alternately stacked, so as to configure a capacitor circuit.

### Dielectric Layer 2

Dielectric ceramic composition constituting dielectric layer 2 include BTZ based dielectric ceramic composition, which is shown by a composition formula: (Ba₁₋ₓCaₓ)ₘ(Ti_{1-y}Zr_{y})O₃ and has a perovskite-type crystal structure, as a main component. Note that an amount of oxide (O) may be slightly deviated from stoichiometric composition of the above formula.

In the formula, “x” is preferably 0≦x≦0.06, more preferably 0≦x≦0.04. “x” is a number of Ca atom. It is possible to arbitrarily shift phase transition point of crystals by changing “x”, namely by changing Ca/Ba ratio. Therefore, capacitance-temperature coefficient, specific permittivity and etc. can be arbitrarily controlled. Note that, in the present embodiment, “x” can be zero (x=0), namely Ca may not be included in the embodiment.

In the formula, “y” is preferably 0.01≦y≦0.08, more preferably 0.02≦y≦0.08. “y” is a number of Zr atom. When “Zr” is too small, dielectric particles tend to have core-shell structure, while when too large, it becomes difficult to set Curie temperature higher when compared to the temperature range of the use.

In the formula, “m” is preferably 0.995≦m≦1.020, more preferably 1.000≦y≦1.006. When “m” is 0.995 or higher, occurrence of semiconductor when fired in a reduced atmosphere can be prevented, and when “m” is 1.020 or lower, it is possible to obtain a dense sintered body without increasing the firing temperature.

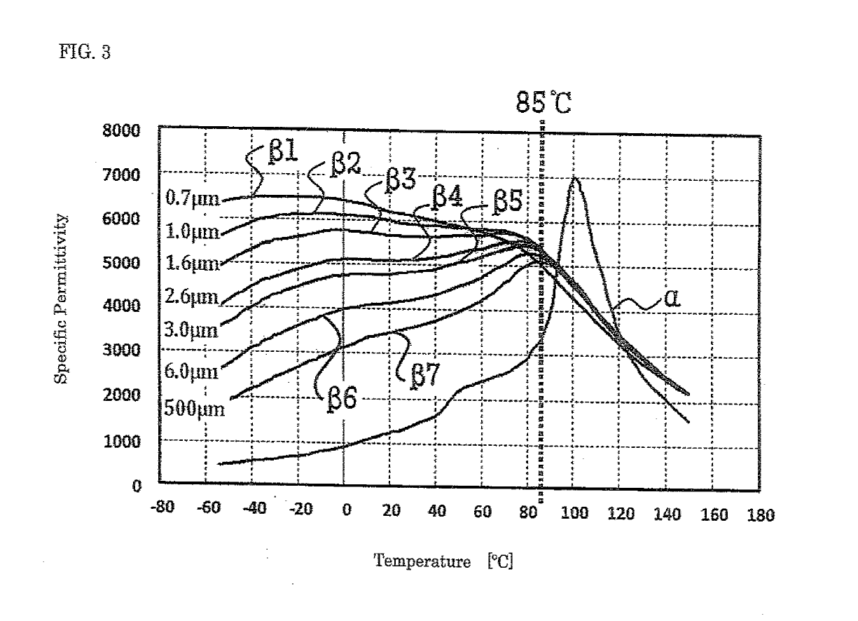

In the present embodiment, Curie temperature Tc of BTZ based dielectric ceramic composition is higher than the temperature range of the multilayer ceramic capacitor used. For instance, as is shown in FIG. 3 as α-curve, Curie temperature Tc of BTZ based dielectric ceramic composition is higher than the temperature range of the use (−55° C. to 85° C.) as is determined by X5R. Namely, Curie temperature Tc of BTZ based dielectric ceramic composition is 85° C.≦Tc≦110° C., more preferably 90° C.≦Tc≦110° C.

Dielectric ceramic composition constituting dielectric layer 2 of the present embodiment may further include subcomponents in addition to the above main component. The first to the fourth subcomponents are preferably included in the present embodiment. The first subcomponent is Mg-oxide, the second subcomponent is at least one selected from Mn-oxides and Cr-oxides, the third subcomponent is R(rare earth)-oxide and the fourth subcomponent is an oxide including Si.

The first subcomponent (Mg-oxide) has an effect to prevent particle growth of raw material powder of main component, which become a base material when firing. Content of Mg-oxide is preferably more than 0 mole and 0.5 mole or less, more preferably, 0.05 to 0.5 mole in terms of MgO, with respect to 100 moles of the main component.

The second subcomponent has effects to accelerate sintering, to heighten IR and to increase IR lifetime. The total content of Mn-oxide or Cr-oxide is 0.05 to 2.0 moles, preferably 0.1 to 1.0 mole, more preferably, 0.1 to 0.5 mole in terms of element with respect to 100 moles of the main component.

The third subcomponent (R-oxide) has effects to increase IR lifetime and to flatten capacitance-temperature characteristic. “R” in the third subcomponent is preferably one kind selected from Y, La, Ce, Pr, Nd, Sm, Gd, Tb, Dy, Ho and Yb. From an aspect of high-temperature load lifetime and capacitance change rate, it is preferably Tb and Y, more preferably, Y. Content of the third subcomponent (R-oxide) is preferably 0.05 to 4.0 moles, more preferably, 0.1 to 2.0 moles with respect to 100 moles of the main component.

Note that the content of R-oxide is not a mole ratio of R-oxide but a mole ratio of R-element alone. Namely, when Y-oxide is used as an R-oxide and content of R-oxide is 1 mole, it does not indicate that ratio of Y₂O₃ is 1 mole but the ratio of Y-element is 1 mole.

The fourth subcomponent (oxides including Si) mainly acts as a sintering aid but it also has an effect to improve deficiencies of initial insulation resistance when layers are made thinner. Content of the fourth subcomponent is preferably 0.1 to 5 moles, preferably, 0.5 to 4 moles, more preferably 0.5 to 2 moles in terms of an oxide, with respect to 100 moles of the main component.

The oxides including Si can be either a simple oxide or a complex oxide. When it is an complex oxide, (Ba, Ca)ₙSiO₂₊ₙ (note that n=0.8 to 1.2) is preferable. Further, “n” in (Ba, Ca)ₙSiO₂₊ₙ is preferably 0 to 2, more preferably 0.8 to 1.2. Note that a ratio of Ba and Ca in the fourth subcomponent is arbitrary, and it can also include one or the other.

Dielectric ceramic composition constituting dielectric layer 2 according to the present embodiment preferably includes the fifth subcomponent in addition to the above main component and the first to the fourth subcomponents. The fifth subcomponent is preferably an oxide of at least one element selected from V, Mo, W, Ta and Nb. From an aspect of high-temperature load lifetime, it is preferably an oxide of Nb or V, more preferably, an oxide of V. Content of the fifth subcomponent is 0 to 0.2 mole, in terms of each element, with respect to 100 moles of the main component.

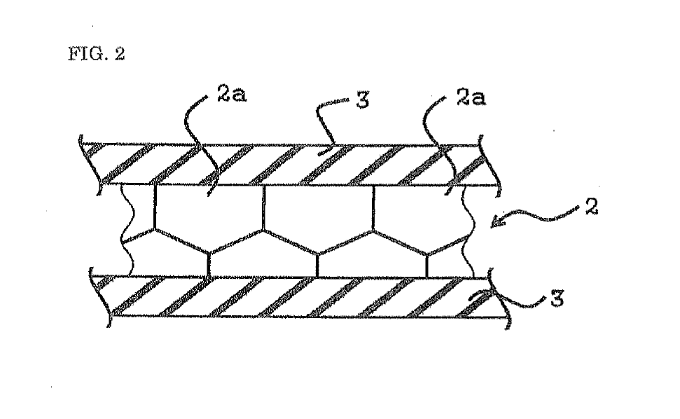

It is preferable that the thickness of dielectric layer 2 is thinned to preferably 3.0 μm or less, more preferably 2.6 μm or less, the most preferably 1.6 μm or less per a layer. It is preferable that the minimum of the thickness is lower, as far as the insulation is maintained. Although it is not particularly limited, for instance, around 1.0 μm is preferable. As is shown in FIG. 2, dielectric layer 2 is constituted from dielectric particles 2a, which do not have so-called core-shell structure. Particle diameter of dielectric particles 2a is preferably 0.1 to 0.5 μm. Grain size of dielectric particles 2a are controlled in order that 1 to 10 particles exist between internal electrode layers 3, 3.

Although the number of stacked layers of dielectric layer 2 is not particularly limited, it is preferably 20 or more, more preferably 50 or more, the most preferably 100 or more. Although maximum number of the stacked layers is not particularly limited, it is approximately 2,000.

### Internal Electrode Layer 3

Although conducting material included in internal electrode layer 3 is not particularly limited, relatively inexpensive base metal can be used since materials constituting dielectric layer 2 have a resistance to reduction. Ni or Ni alloy is preferable for base metal used for the conducting material. As for Ni alloy, an alloy of Ni and one or more element selected from Mn, Cr, Co and Al is preferable; and Ni content in the alloy is preferably 95 wt % or more. Note that, in Ni or Ni alloy, various kinds of minor components, such as P, may be included for about 0.1 wt % or less. Although thickness of internal electrode layer 3 is suitably determined according to its use, in general, it is preferably around 0.3 to 2.0 μm, more preferably 0.3 to 1.0 μm.

### Outer Electrode 4

Although conducting material included in external electrode 4 is not particularly limited, inexpensive Ni, Cu or their alloys may be used in the present embodiment. Although a thickness of external electrode 4 can be suitably determined according to its use, it is around 10 to 50 μm in general.

### Manufacturing Method of Multilayer Ceramic Capacitor 1

The multilayer ceramic capacitor 1 of the present embodiment is manufactured by, as is the same with conventional multilayer ceramic capacitors, preparing green chip with normal printing method or sheet method using paste, firing the same, then printing or transferring external electrode thereon and baking the same. The manufacturing method will specifically be described herein after.

Firstly, dielectric raw material powder included in dielectric layer paste is prepared and then made to a paste in order to prepare a dielectric layer paste.

The dielectric layer paste may be either an organic paste, to which the dielectric raw material powder and an organic vehicle are kneaded, or a water-based paste.

As for the dielectric raw material powder, the above-mentioned oxides, their mixtures and their composite oxides may be used. It is also possible to suitably select from a variety of compounds to become the above mentioned oxides or their composite oxides after firing, for example, carbonate, oxalate, nitrate, hydroxide, organic metallic compound, etc., and to mix them to use. Contents of each compound in dielectric raw material powder are determined in order that their composition after firing shows the abovementioned dielectric ceramic composition.

Organic vehicle is obtained by dissolving a binder in an organic solvent. The binder used in the organic vehicle is not particularly limited and may be suitably selected from various kinds of normal binders such as ethyl cellulose, polyvinyl butyral, etc. The organic solvent is also not particularly limited and may be suitably selected from various kinds of organic solvent, such as terpineol, butyl carbitol, acetone, toluene, etc., according to a utilized method, such as printing method or sheet method.

Further, when the dielectric layer paste is a water-based paste, a water-based vehicle, which a water-soluble binder, dispersants, etc. are solved in water, and the dielectric material would be kneaded. The water-soluble binder used for water-based vehicle is not particularly limited, and for example, polyvinyl alcohol, cellulose, water-soluble acrylic resin, etc., may be used.

An internal electrode layer paste is prepared by kneading such as the conductive material constituted by various kinds of conductive metals and alloys, various kinds of oxides which become the above-mentioned conductive material after firing, organic metal compounds or resinate with the abovementioned organic vehicle.

The external electrode paste is prepared as is the same with the above mentioned internal electrode layer paste.

Content of the organic vehicle in each paste mentioned above is not particularly limited, and may be a normal content, for example, around 1 to 5 wt % of the binder or around 10 to 50 wt % of the solvent. Also, each paste may include additives selected from a variety of dispersants, plasticizers, dielectrics, insulator, etc., if needed. Their total content is preferably 10 wt % or less.

When printing method is used, the dielectric layer paste and the internal electrode layer paste are stacked and printed on a substrate, such as PET, cut to a predetermined form and then removed from the substrate to obtain a green chip.

Also, when sheet method is used, a green sheet is formed with dielectric layer paste, the internal electrode layer paste is printed thereon, and then, the results are stacked to obtain a green chip.

Binder removal treatment and firing treatment are performed to the green chip before firing. Binder removal treatment and firing treatment may be suitably determined in accordance with the type of conducting material in the internal electrode layer paste. After fired in a reduced atmosphere, it is preferable that anneal is performed to the capacitor element body. Anneal is a process for re-oxidizing dielectric layer and thereby remarkably elongates IR lifetime, which improves reliability.

End surface polishing by barrel polishing or sand blast, etc. is performed on the capacitor element body obtained as above, and the external electrode paste is printed or transferred thereon and fired to form the external electrodes 4. It is preferable that the firing conditions of the external electrode paste is, for instance, approximately 10 minutes to 1 hour at 600 to 800° C. under a wet mixed gas of N₂ and H₂. A cover layer is then formed by plating, etc. on the surface of the external electrode 4, if necessary.

A multilayer ceramic capacitor of the present invention manufactured as above is mounted on a printed substrate, etc. by such as soldering, and used for a variety of electronic apparatuses, etc.

Note that the present invention is not limited to the embodiments described above and may be variously modified within the scope of the present invention.

### EXAMPLES

Below, the present invention will be explained based on furthermore detailed examples, but the present invention is not limited to the examples.

### Example 1

As for a raw material of a main component, (Ba₁₋ₓCaₓ)ₘ(Ti_{1-y}Zr_{y})O₃, wherein average particle diameter of raw material is 0.35 μm, was prepared. Further, as for a raw materials of the subcomponents, MgCO₃ (the first subcomponent), MnO (the other second subcomponent), Y₂O₃ (the other third subcomponent), SiO₂ (the other fourth subcomponent) and V₂O₅ (the other fifth subcomponent) were prepared. The above prepared raw materials of the main component and the subcomponents were mixed by a ball mill, so as to make each amount as shown in Tables 1 and 3. The obtained mixture powder was preliminarily calcined at 1,000° C. and the calcined powder having an average particle diameter of 0.2 μm was prepared. Next, the obtained calcined powder was wet pulverized by a ball-mill for 15 hours and dried to obtain dielectric raw material. Note that, MgCO₃ was included in the dielectric ceramic composition as MgO after firing.

Next, 100 parts by weight of the obtained dielectric raw material, 10 parts by weight of polyvinyl butyral resin, 5 parts by weight of dibutyl phthalate (DBP) as a plasticizer and 100 parts by weight of alcohol as solvent were mixed by a ball-mill and were pasted to obtain dielectric layer paste.

Further, aside from the above dielectric layer paste, 45 parts by weight of Ni powder, 52 parts by weight of terpineol and 3 parts by weight of ethyl cellulose were kneaded by a triple-roll to form a slurry, and an internal electrode layer paste was obtained.

The above obtained dielectric layer paste was used to form a green sheet on a PET film, in order that the green sheet becomes 2 μm thick after drying. Next, an electrode layer was printed thereon in a predetermined pattern by using the internal electrode layer paste, and then the sheet was removed from PET film to manufacture the green sheet having the electrode layer. Then a plural number of green sheets having an electrode layer were stacked and adhered by pressure so as to obtain a green stacked body. The green stacked body was then cut to a predetermined size to obtain a green chip.

Next, processes of removing binder, firing and annealing were performed on the obtained green chip under the following conditions and multilayer ceramic fired body was obtained.

The binder removal process was performed under a condition that a temperature rising rate of 25° C./hour, a holding temperature of 250° C., a holding time of 8 hours, and the atmosphere of air.

The firing process was performed under a condition that a temperature rising rate of 200° C./hour, a holding temperature of 1200° C., a holding time of 2 hours, a temperature lowering rate of 200° C./hour and an atmospheric gas of a wet mixed gas of N₂+H₂ (oxygen partial pressure of 10⁻¹² MPa).

The annealing process was performed under a condition that a temperature rising rate of 200° C./hour, a holding temperature of 1,000° C., a holding time of 2 hours, temperature lowering rate of 200° C./hour, an atmospheric gas of a wet N₂ gas (oxygen partial pressure of 10⁻⁷ MPa).

Next, after polishing end faces of the obtained multilayer ceramic fired body by sand blast, In—Ga as an external electrode was printed thereon and a multilayer ceramic capacitor sample having the configuration shown in FIG. 1 was obtained. Size of the obtained capacitor sample was 2.0 mm×1.2 mm×0.5 mm, thickness of one dielectric layer was 1.6 μm, thickness of one internal electrode layer was 1.2 μm and a number of dielectric layers sandwiched between internal electrode layers was 10.

As is shown in Tables 1 and 3, mole ratio of each component in the main component and molar number of the subcomponents are varied, and specific permittivity (∈s), insulation resistance (IR), capacitance change rate (TC) and high-temperature load lifetime (HALT) of the obtained each capacitor sample were measured by the following methods. Results are shown in Tables 2 and 4.

### Specific Permittivity ∈s

For each capacitor sample, capacitance at reference temperature of 25° C. was measured with digital LCR meter (4274A by YHP) under the conditions of frequency at 1 kHz and input signal level (measured voltage) at 1.0 Vrms, and then, specific permittivity ∈s (no unit) was calculated from the capacitance. Higher specific permittivity is preferable, and 4,000 or more were determined “good” in the present examples. Results are shown in Tables 2 and 4.

### Insulation Resistance (IR)

For each capacitor sample, an insulation resistance (IR) was measured by an insulation resistance meter (R8340A by Advantest), after applying a direct voltage of DC 10V at 25° C. for 60 seconds. CR product was obtained by multiplying the above obtained capacitance “C” and insulation resistance IR. In the present examples, CR products of 2,000 Ω·F or more were determined “good”. Results are shown in Tables 2 and 4.

### Capacitance Change Ratio (TC)

For each capacitor sample, capacitances at −25° C. and 105° C. were respectively measured with digital LCR meter (4284A by YHP) under the conditions of frequency at 1 kHz and input signal level (measured voltage) at 1 Vrms. Then change rate (unit is %) of capacitance at −55° C. and 85° C. to the capacitance at reference temperature of 25° C. were respectively calculated. It was evaluated whether the change rate is within ±15% or not. Results are shown in Tables 2 and 4.

### High-Temperature Load Lifetime (HALT)

The capacitor sample was maintained in the state of applying direct voltage at 180° C. under electric field of 25 V/μm to measure lifetime, by which the high temperature accelerated lifetime (HALT) was evaluated. In the present example, the time from the start of applying voltage until the insulation resistance was dropped by one digit was determined as lifetime. Also, the high temperature accelerated lifetime was evaluated for 10 capacitor samples. In the present examples, 10 hours or more was evaluated as being favorable. The results are shown in Tables 2 and 4.

### Present or Absent of Core-Shell Structure

A section of capacitor sample was observed by a transmission electron microscopy, and it was determined that the core-shell structure is “present” when 10 or more dielectric particles having core-shell structure were observed within 10×10 μm, and otherwise it was determined “absent”.

Evaluation 1 for Samples No. 1 to 5

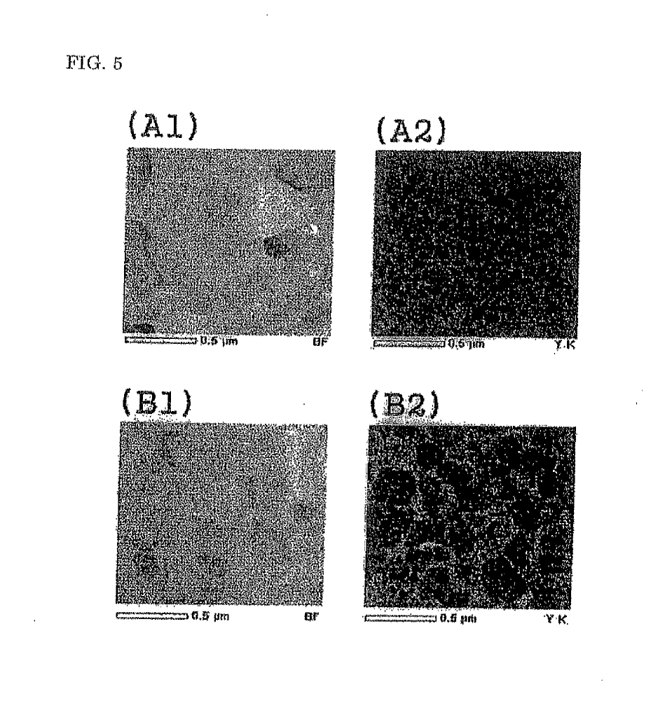

From Tables 1 and 2, it was confirmed that sample numbers 1 to 4, which are examples having no core-shell structure, were superior than sample number 6, which is an example having core-shell structure, in terms of higher specific permittivity. FIGS. 5 (A1) and (A2) show cross sectional pictures of dielectric particles, which do not have core-shell structure, in sample number 3. FIGS. 5 (B1) and (B2) show cross sectional pictures of dielectric particles having core-shell structure in sample number 5. Note that FIGS. 5 (A1) and (B1) are images of transmission electron microscope (TEM), while FIGS. 5 (A2) and (B2) are mapping images of Y element respectively of FIGS. 5 (A1) and (B1).

Note that graph 61 in FIG. 3 indicates changes in specific permittivity “∈s” of capacitor sample number 3 to temperature. For comparison, FIG. 3 also show graphs of capacitor samples which have the same composition with sample number 3, and which only thickness varies as is shown in FIG. 3. It was confirmed that, by making the thickness of dielectric layer to preferably 3 μm or less, more preferably 2.6 μm or less, more preferably 1.6 μm or less, specific permittivity can be maintained nearly constant to preferably 4,000 or more, more preferably 5,000 or more, the most preferably 6,000 or more within the temperature range of the use (−55° C. to 85° C.). Further, it was confirmed that X5R characteristic can be satisfied.

It was confirmed that sample number 5 is inferior to examples of the invention in capacitance-temperature characteristic, since sample number 5 contains too much calcium in main component.

### Evaluation 2 for Samples No. 6 to 11

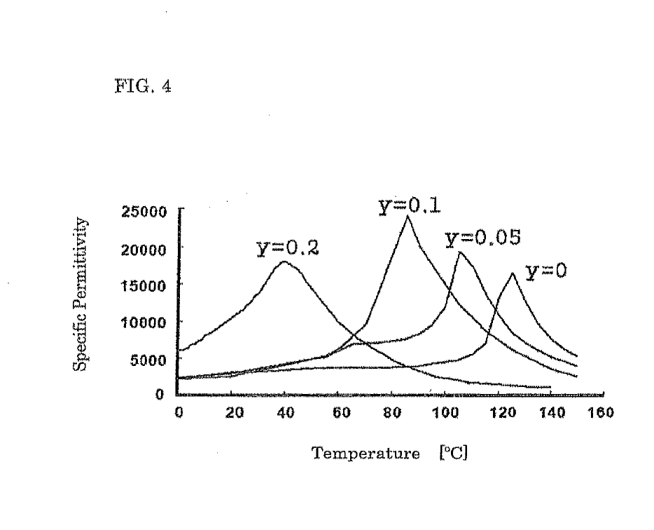

As is shown in Tables 1 and 2, by comparing sample numbers 6 to 11, it was confirmed that “y” in main component is preferably 0.01 to 0.08. Note that, as is shown in FIG. 4, when “y” is 0.1 or more, Curie temperature becomes less than 85° C. and effects of the invention cannot be achieved.

### Evaluation 3 for Samples No. 12 to 15

As is shown in Tables 1 and 2, by comparing sample numbers 12 to 15, it was confirmed that “m” in main component is preferably 0.950 to 1.050.

### Evaluation 4 for Samples No. 16 to 19

As is shown in Tables 1 and 2, by comparing sample numbers 16 to 19, it was confirmed that Mg oxide as the first subcomponent is preferably 0.05 to 0.5 mole with respect to 100 moles of the main component.

### Evaluation 5 for Samples No, 20 to 24

As is shown in Tables 1 and 2, by comparing sample numbers 20 to 23, it was confirmed that Mn oxide as the second subcomponent is preferably 0.05 to 2 moles with respect to 100 moles of the main component. Further, as is shown by sample number 24, the same effects can be expected when Cr is used instead of Mn.

### Evaluation 6 for Samples No. 25 to 28

As is shown in Tables 3 and 4, it was confirmed that the same effects as is obtained from sample number 3 can be expected, when yttrium oxide of the third subcomponent is 0.05 to 4 moles with respect to 100 moles of the main component.

### Evaluation 7 for Samples No. 29 to 38

As is shown in Tables 3 and 4, it was confirmed that the same effects as is obtained from sample number 3 can be expected, when yttrium oxide of the third subcomponent is changed to oxides of La, Ce, Pr, Nd, Sm, Gd, Tb, Dy, Ho and Yb.

### Evaluation 8 for Samples No. 39 to 41

As is shown in Tables 3 and 4, it was confirmed that the same effects as is obtained from sample number 3 can be expected, when silicon oxide of the fourth subcomponent is 0.1 to 5 moles with respect to 100 moles of the main component.

### Evaluation 9 for Samples No. 42 to 44

As is shown in Tables 3 and 4, it was confirmed that the same effects as is obtained from sample number 3 can be expected, when silicon oxide of the fourth subcomponent is changed to the complex oxide as is shown in Table 3.

### Evaluation 10 for Samples No. 45 to 46

As is shown in Tables 3 and 4, it was confirmed that the same effects as is obtained from sample number 3 can be expected, when vanadium oxide of the fifth subcomponent is 0 to 0.2 mole with respect to 100 moles of the main component.

### Evaluation 11 for Samples No. 47 to 50

As is shown in Tables 3 and 4, it was confirmed that the same effects as is obtained from sample number 3 can be expected, when vanadium oxide of the fifth subcomponent is changed to oxides of Mo, W, Ta and Nb.

TABLE 1

| | | Compositions of main component | | | | Cntent of subcomponents with respect to 100 | | | | | | | |
|---|---|---|---|---|---|---|---|---|---|---|---|---|---|
| | | (Ba₁ − ₓCaₓ)ₘ(Ti₁ − _{y}Zrᵥ)O₃ | | | | moles of the main component [mol] | | | | | | | |
| | | | | | the first | the second | | the third | | | | the fifth | |
| | | x | y | m | subcompo- | subcomponent | | subcomponent | | the fourth | | subcomponent | |
| | items | 0~ | 0.01~ | 0.950~ | nent (Mg) | (Mn, Cr) | | (Rare earth) | | subcomponent | | (V, Mo, W, Ta, Nb) | |
| No. | ranges | 0.06 | 0.08 | 1.050 | 0~0.5 | A | 0.05~2 | R | 0.05~4 | Types | 0.1~5 | D | 0~0.2 |

| | | | | | | | | | | | | |
|---|---|---|---|---|---|---|---|---|---|---|---|---|
| 1 | 0 | 0.06 | 1 | 0.1 | Mn | 0.2 | Y | 1.2 | SiO₂ | 1.2 | V | 0.1 |
| 2 | 0.02 | 0.06 | 1 | 0.1 | Mn | 0.2 | Y | 1.2 | SiO₂ | 1.2 | V | 0.1 |
| 3 | 0.04 | 0.06 | 1 | 0.1 | Mn | 0.2 | Y | 1.2 | SiO₂ | 1.2 | V | 0.1 |
| 4 | 0.06 | 0.06 | 1 | 0.1 | Mn | 0.2 | Y | 1.2 | SiO₂ | 1.2 | V | 0.1 |
| 5* | 0.08 | 0.06 | 1 | 0.1 | Mn | 0.2 | Y | 1.2 | SiO₂ | 1.2 | V | 0.1 |
| 6* | 0 | 0 | 1 | 0.1 | Mn | 0.2 | Y | 1.2 | SiO₂ | 1.2 | V | 0.1 |
| 7 | 0 | 0.01 | 1 | 0.1 | Mn | 0.2 | Y | 1.2 | SiO₂ | 1.2 | V | 0.1 |
| 8 | 0 | 0.02 | 1 | 0.1 | Mn | 0.2 | Y | 1.2 | SiO₂ | 1.2 | V | 0.1 |
| 9 | 0 | 0.04 | 1 | 0.1 | Mn | 0.2 | Y | 1.2 | SiO₂ | 1.2 | V | 0.1 |
| 10 | 0 | 0.08 | 1 | 0.1 | Mn | 0.2 | Y | 1.2 | SiO₂ | 1.2 | V | 0.1 |
| 11* | 0 | 1.00 | 1 | 0.1 | Mn | 0.2 | Y | 1.2 | SiO₂ | 1.2 | V | 0.1 |
| 12* | 0.04 | 0.06 | 0.9 | 0.1 | Mn | 0.2 | Y | 1.2 | SiO₂ | 1.2 | V | 0.1 |
| 13 | 0.04 | 0.06 | 0.95 | 0.1 | Mn | 0.2 | Y | 1.2 | SiO₂ | 1.2 | V | 0.1 |
| 14 | 0.04 | 0.06 | 1.05 | 0.1 | Mn | 0.2 | Y | 1.2 | SiO₂ | 1.2 | V | 0.1 |
| 15* | 0.04 | 0.06 | 1.1 | 0.1 | Mn | 0.2 | Y | 1.2 | SiO₂ | 1.2 | V | 0.1 |
| 16* | 0.04 | 0.06 | 1 | 0 | Mn | 0.2 | Y | 1.2 | SiO₂ | 1.2 | V | 0.1 |
| 17 | 0.04 | 0.06 | 1 | 0.05 | Mn | 0.2 | Y | 1.2 | SiO₂ | 1.2 | V | 0.1 |
| 18 | 0.04 | 0.06 | 1 | 0.5 | Mn | 0.2 | Y | 1.2 | SiO₂ | 1.2 | V | 0.1 |
| 19* | 0.04 | 0.06 | 1 | 1.0 | Mn | 0.2 | Y | 1.2 | SiO₂ | 1.2 | V | 0.1 |
| 20* | 0.04 | 0.06 | 1 | 0.1 | Mn | 0.02 | Y | 1.2 | SiO₂ | 1.2 | V | 0.1 |
| 21 | 0.04 | 0.06 | 1 | 0.1 | Mn | 0.05 | Y | 1.2 | SiO₂ | 1.2 | V | 0.1 |
| 22 | 0.04 | 0.06 | 1 | 0.1 | Mn | 2 | Y | 1.2 | SiO₂ | 1.2 | V | 0.1 |
| 23* | 0.04 | 0.06 | 1 | 0.1 | Mn | 3 | Y | 1.2 | SiO₂ | 1.2 | V | 0.1 |
| 24 | 0.04 | 0.06 | 1 | 0.1 | Cr | 0.2 | Y | 1.2 | SiO₂ | 1.2 | V | 0.1 |

TABLE 2

| | | Initial characteristic | | | | | |
|---|---|---|---|---|---|---|---|
| | | | CR | Capacitance | High- | | |
| | | Specific | products | change ratio | temperature | | |
| | | Permittivity | (Ω · F) | −55° C.~ | load lifetime | | Determin- |
| | items | (εs) 4,000 | 2,000 | 85° C. | (HALT) [h] | Core-shell | ation good |
| No. | ranges | or more | or more | ±15% | 10 h or more | structure | or bad |

| | | | | | | |
|---|---|---|---|---|---|---|
| 1 | 5,400 | 4,000 | good | 12 | absent | good |
| 2 | 6,200 | 4,100 | good | 18 | absent | good |
| 3 | 6,500 | 4,000 | good | 20 | absent | good |
| 4 | 6,800 | 3,800 | good | 14 | absent | good |
| 5* | 7,500 | 3,500 | bad | 4 | absent | bad |
| 6* | 3,500 | 2,200 | bad | 4 | present | bad |
| 7 | 4,200 | 2,500 | good | 18 | absent | good |
| 8 | 4,800 | 3,200 | good | 20 | absent | good |
| 9 | 5,100 | 3,800 | good | 14 | absent | good |
| 10 | 5,600 | 4,100 | good | 16 | absent | good |
| 11* | 7,200 | 3,900 | bad | 14 | absent | bad |
| 12* | 9,500 | 2,500 | bad | <1 | absent | bad |
| 13 | 8,000 | 2,800 | good | 11 | absent | good |
| 14 | 4,800 | 3,900 | good | 25 | absent | good |
| 15* | 2,200 | 3,500 | good | 14 | present | bad |
| 16* | 8,100 | 2,500 | bad | 2 | absent | bad |
| 17 | 6,600 | 3,800 | good | 18 | absent | good |
| 18 | 5,100 | 4,000 | good | 20 | absent | good |
| 19* | 2,800 | 3,500 | bad | 28 | present | bad |
| 20* | 7,200 | 1,200 | good | <1 | absent | bad |
| 21 | 6,800 | 3,600 | good | 16 | absent | good |
| 22 | 4,500 | 4,000 | good | 20 | absent | good |
| 23* | 3,200 | 4,100 | bad | 21 | absent | bad |
| 24 | 6,100 | 3,800 | good | 14 | absent | good |

TABLE 3

| | | Compositions of main component | | | | Cntent of subcomponents with respect to 100 | | | | | | | |
|---|---|---|---|---|---|---|---|---|---|---|---|---|---|
| | | (Ba₁ − ₓCaₓ)ₘ(Ti1 − _{y}Zrᵥ)O₃ | | | | moles of the main component [mol] | | | | | | | |
| | | | | | the first | the second | | the third | | | | the fifth | |
| | | x | y | m | subcompo- | subcomponent | | subcomponent | | the fourth | | subcomponent | |
| | items | 0~ | 0.01~ | 0.950~ | nent (Mg) | (Mn, Cr) | | (Rare earth) | | subcomponent | | (V, Mo, W, Ta, Nb) | |
| No. | ranges | 0.06 | 0.08 | 1.050 | 0~0.5 | A | 0.05~2 | R | 0.05~4 | Types | 0.1~5 | D | 0~0.2 |

| | | | | | | | | | | | | |
|---|---|---|---|---|---|---|---|---|---|---|---|---|
| 25 | 0.04 | 0.06 | 1 | 0.1 | Mn | 0.2 | Y | 0.05 | SiO₂ | 1.2 | V | 0.1 |
| 26 | 0.04 | 0.06 | 1 | 0.1 | Mn | 0.2 | Y | 1 | SiO₂ | 1.2 | V | 0.1 |
| 27 | 0.04 | 0.06 | 1 | 0.1 | Mn | 0.2 | Y | 4 | SiO₂ | 1.2 | V | 0.1 |
| 28* | 0.04 | 0.06 | 1 | 0.1 | Mn | 0.2 | Y | 8 | SiO₂ | 1.2 | V | 0.1 |
| 29 | 0.04 | 0.06 | 1 | 0.1 | Mn | 0.2 | La | 1.2 | SiO₂ | 1.2 | V | 0.1 |
| 30 | 0.04 | 0.06 | 1 | 0.1 | Mn | 0.2 | Ce | 1.2 | SiO₂ | 1.2 | V | 0.1 |
| 31 | 0.04 | 0.06 | 1 | 0.1 | Mn | 0.2 | Pr | 1.2 | SiO₂ | 1.2 | V | 0.1 |
| 32 | 0.04 | 0.06 | 1 | 0.1 | Mn | 0.2 | Nd | 1.2 | SiO₂ | 1.2 | V | 0.1 |
| 33 | 0.04 | 0.06 | 1 | 0.1 | Mn | 0.2 | Sm | 1.2 | SiO₂ | 1.2 | V | 0.1 |
| 34 | 0.04 | 0.06 | 1 | 0.1 | Mn | 0.2 | Gd | 1.2 | SiO₂ | 1.2 | V | 0.1 |
| 35 | 0.04 | 0.06 | 1 | 0.1 | Mn | 0.2 | Tb | 1.2 | SiO₂ | 1.2 | V | 0.1 |
| 36 | 0.04 | 0.06 | 1 | 0.1 | Mn | 0.2 | Dy | 1.2 | SiO₂ | 1.2 | V | 0.1 |
| 37 | 0.04 | 0.06 | 1 | 0.1 | Mn | 0.2 | Ho | 1.2 | SiO₂ | 1.2 | V | 0.1 |
| 38 | 0.04 | 0.06 | 1 | 0.1 | Mn | 0.2 | Yb | 1.2 | SiO₂ | 1.2 | V | 0.1 |
| 39 | 0.04 | 0.06 | 1 | 0.1 | Mn | 0.2 | Y | 1.2 | SiO₂ | 0.1 | V | 0.1 |
| 40 | 0.04 | 0.06 | 1 | 0.1 | Mn | 0.2 | Y | 1.2 | SiO₂ | 0.5 | V | 0,1 |
| 41 | 0.04 | 0.06 | 1 | 0.1 | Mn | 0.2 | Y | 1.2 | SiO₂ | 5 | V | 0.1 |
| 42 | 0.04 | 0.06 | 1 | 0.1 | Mn | 0.2 | Y | 1.2 | BaSiO₃ | 1.2 | V | 0.1 |
| 43 | 0.04 | 0.06 | 1 | 0.1 | Mn | 0.2 | Y | 1.2 | CaSiO₃ | 1.2 | V | 0.1 |
| 44 | 0.04 | 0.06 | 1 | 0.1 | Mn | 0.2 | Y | 1.2 | BaCaSiO₃ | 1.2 | V | 0.1 |
| 45 | 0.04 | 0.06 | 1 | 0.1 | Mn | 0.2 | Y | 1.2 | SiO₂ | 1.2 | V | 0 |
| 46 | 0.04 | 0.06 | 1 | 0.1 | Mn | 0.2 | Y | 1.2 | SiO₂ | 1.2 | V | 0.2 |
| 47 | 0.04 | 0.06 | 1 | 0.1 | Mn | 0.2 | Y | 1.2 | SiO₂ | 1.2 | Mo | 0.1 |
| 48 | 0.04 | 0.06 | 1 | 0.1 | Mn | 0.2 | Y | 1.2 | SiO₂ | 1.2 | W | 0.1 |
| 49 | 0.04 | 0.06 | 1 | 0.1 | Mn | 0.2 | Y | 1.2 | SiO₂ | 1.2 | Ta | 0.1 |
| 50 | 0.04 | 0.06 | 1 | 0.1 | Mn | 0.2 | Y | 1.2 | SiO₂ | 1.2 | Nb | 0.1 |

TABLE 4

| | | Initial characteristic | | | | | |
|---|---|---|---|---|---|---|---|
| | | | CR | Capacitance | High- | | |
| | | Specific | products | change ratio | temperature | | |
| | | Permittivity | (Ω · F) | −55° C.~ | load lifetime | | Determin- |
| | items | (εs) 4,000 | 2,000 | 85° C. | (HALT) [h] | Core-shell | ation good |
| No. | ranges | or more | or more | ±15% | 10 h or more | structure | or bad |

| | | | | | | |
|---|---|---|---|---|---|---|
| 25 | 7,200 | 4,500 | good | 11 | absent | good |
| 26 | 6,600 | 4,100 | good | 18 | absent | good |
| 27 | 4,800 | 4,000 | good | 21 | absent | good |
| 28* | 2,500 | 3,100 | bad | 22 | absent | bad |
| 29 | 5,100 | 2,800 | good | 12 | absent | good |
| 30 | 5,400 | 3,000 | good | 16 | absent | good |
| 31 | 5,300 | 3,100 | good | 11 | absent | good |
| 32 | 5,500 | 3,000 | good | 11 | absent | good |
| 33 | 5,600 | 3,200 | good | 15 | absent | good |
| 34 | 6,100 | 3,000 | good | 16 | absent | good |
| 35 | 5,800 | 3,500 | good | 14 | absent | good |
| 36 | 6,000 | 4,000 | good | 18 | absent | good |
| 37 | 6,400 | 3,800 | good | 20 | absent | good |
| 38 | 5,400 | 3,500 | good | 18 | absent | good |
| 39 | 7,200 | 4,500 | good | 11 | absent | good |
| 40 | 6,800 | 4,200 | good | 14 | absent | good |
| 41 | 4,200 | 4,200 | good | 16 | absent | good |
| 42 | 5,800 | 4,500 | good | 24 | absent | good |
| 43 | 5,600 | 4,600 | good | 21 | absent | good |
| 44 | 5,900 | 4,100 | good | 20 | absent | good |
| 45 | 6,600 | 4,500 | good | 16 | absent | good |
| 46 | 6,200 | 3,600 | good | 22 | absent | good |
| 47 | 6,000 | 3,500 | good | 18 | absent | good |
| 48 | 5,800 | 3,800 | good | 20 | absent | good |
| 49 | 5,900 | 3,200 | good | 16 | absent | good |
| 50 | 6,200 | 3,900 | good | 21 | absent | good |

1. A multilayer ceramic capacitor in which dielectric layers and internal electrode layers are alternately stacked, wherein
the dielectric layers include BTZ based dielectric ceramic composition, in which Ti is substituted by 1 to 8 mol % of Zr with respect to Ti, as a main component
dielectric particles constituting the BTZ based dielectric ceramic composition substantially do not have shell structures, and
Curie temperature of the BTZ based dielectric ceramic composition is higher than a temperature range of the multilayer ceramic capacitor used.

2. The multilayer ceramic capacitor as set forth in claim 1, wherein Curie temperature Tc of the BTZ based dielectric ceramic composition is 85° C.≦Tc≦110° C.

3. The multilayer ceramic capacitor as set forth in claim 1, wherein thickness of the dielectric layer is 3 μm or less.

4. The multilayer ceramic capacitor as set forth in claim 2, wherein thickness of the dielectric layer is 3 μm or less.

5. The multilayer ceramic capacitor as set forth in claim 1, wherein capacitance change rate to temperature is 15% or less at −55 to 85° C., which is the temperature range of multilayer ceramic capacitor used.

6. The multilayer ceramic capacitor as set forth in claim 2, wherein capacitance change rate to temperature is 15% or less at −55 to 85° C., which is the temperature range of multilayer ceramic capacitor used.

7. The multilayer ceramic capacitor as set forth in claim 1, wherein the BTZ based dielectric ceramic composition is dielectric oxide shown by a general formula (Ba₁₋ₓCaₓ)ₘ (Ti_{1-y}Zr_{y})O₃ where 0≦x≦0.06, 0.01≦y≦0.08 and 0.950≦m≦1.050.

8. The multilayer ceramic capacitor as set forth in claim 2, wherein the BTZ based dielectric ceramic composition is dielectric oxide shown by a general formula (Ba₁₋ₓCaₓ)ₘ (Ti_{1-y}Zr_{y})O₃ where 0≦x≦0.06, 0.01≦y≦0.08 and 0.950≦m≦1.050.
